(19) United States
(12) Patent Application Publication
(10) Pub. No.: US 2007/0101369 A1
(43) Pub. Date: May 3, 2007

(54) Method and apparatus for providing summaries of missed portions of television programs

(76) Inventor: Blaine H. Dolph, Western Springs, IL (US)

Correspondence Address: IBM CORP (YA);C/O YEE & ASSOCIATES PC, P.O. BOX 802333, DALLAS, TX, 75380, US

(21) Appl. No.: 11/264,636

(22) Filed: Nov. 1, 2005

(51) Int. Cl. H04N 7/10; G06F 3/00; G06F 13/00; H04N 7/025; H04N 7/16; H04N 5/445

(52) U.S. Cl. 725/46; 725/45; 725/34; 725/35; 725/135

(57) ABSTRACT

A method and apparatus are disclosed for providing a television viewer with a summary of a portion of a program that he or she has missed, after switching to the program at some time after the program has begun. Generally, the times at which the viewer first tuned to a program, left the program and then returned to it would respectively be monitored. A summary for a missed portion of the program, as determined from these times, would then be furnished to the viewer. In a useful embodiment of the invention, a method is carried out in association with an array of data transmission channels, wherein the channels are respectively connectible to a video receiver or like device, and video content is simultaneously transmitted through each of the channels. The receiver is operated to display the video content transmitted through a first one of the channels during a first time period, and to display the video content transmitted through a second one of the channels during a second time period that follows the first time period. The method further comprises generating a summary of the video content transmitted through the second channel during the first time period, and then presenting the summary to a user of the video receiver during the second time period.

### BACKGROUND OF THE INVENTION

1. Field of the Invention

The invention disclosed and claimed herein generally pertains to a method and apparatus for furnishing a television user with a summary of an unviewed portion of a program of interest. More particularly, the invention pertains to a method of the above type wherein a viewer has access to television programs on different channels during the same time period, and can receive a summary of a previously missed portion of the program currently being viewed.

2. Description of the Related Art

It is very common for a television viewer to change channels, after viewing one program for a period of time, to go to a second program. After a further period of time, the viewer may switch to a program on a third channel, or alternatively go back to the first program. The latter situation is illustrated in FIG. 1.

FIG. 1 shows Programs 1 and 2 on different channels, being made available simultaneously to a viewer during a 60-minute time slot. The viewer begins watching Program 1 from its beginning. After 30 minutes, the viewer switches the channel to Program 2. At 40 minutes into the time slot, the viewer switches back to Program 1, for the remainder of the 60-minute program period.

When the viewer turns to Program 2, he or she has already missed the first half of such program. The missed content may include things that are crucial for enjoyment or appreciation of the remainder of Program 2. For example, if Program 2 was a drama or mystery, the viewer may have missed previously presented facts that were essential, in order to understand the plot of the program. If Program 2 was a sporting event, the viewer may have missed key plays or other action that would be of great interest to the viewer. Moreover, in turning back to Program 1, after viewing Program 2 for 10 minutes as shown by FIG. 1, the viewer may have missed important information, events or other significant content pertaining to Program 1.

It is anticipated that there would be significant benefit if a television viewer, when switching to a program that was already underway, could immediately be provided with a summary of the portion of the program that he or she had missed. Usefully, a summary could be provided for any previously missed program segment, regardless of length. This would include, for example, a summary of the 30 minutes of Program 2 that was missed by the viewer, as well as a summary of the 10 minutes of Program 1 that was missed.

### SUMMARY OF THE INVENTION

The invention generally provides a television viewer with a summary of a portion of a program that he or she has missed, after switching to the program at some time after the program has begun. In some embodiments, the viewer would receive a summary covering a program portion from the program beginning to the time the viewer first tuned to the program channel. In other embodiments, where the viewer was tuned to the program channel when the program began, the times at which the viewer left, and then returned to, the program would be monitored. A summary for the program portion between these times would then be furnished to the viewer. In a useful embodiment of the invention, a method is carried out in association with an array of data transmission channels, wherein the channels are respectively connectible to a video receiver or like device, and video content is simultaneously transmitted through each of the channels. The receiver is operated to display the video content transmitted through a first one of the channels during a first time period, and to display the video content transmitted through a second one of the channels during a second time period that follows the first time period. The method further comprises generating a summary of the video content that was transmitted through the second channel during the first time period. This summary is then presented to a user of the video receiver, during the second time period.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a schematic diagram for use in illustrating important objectives of an embodiment of the invention.

FIG. 2 is a block diagram showing a system for implementing an embodiment of the invention.

FIG. 3 is a block diagram showing a data processing system that may be adapted for use as a control computer in the system of FIG. 2.

FIG. 4 is a flow chart showing successive steps in implementing the embodiment of FIG. 2.

FIG. 5 is a block diagram showing an alternative media repository for a modification of the embodiment of FIG. 2.

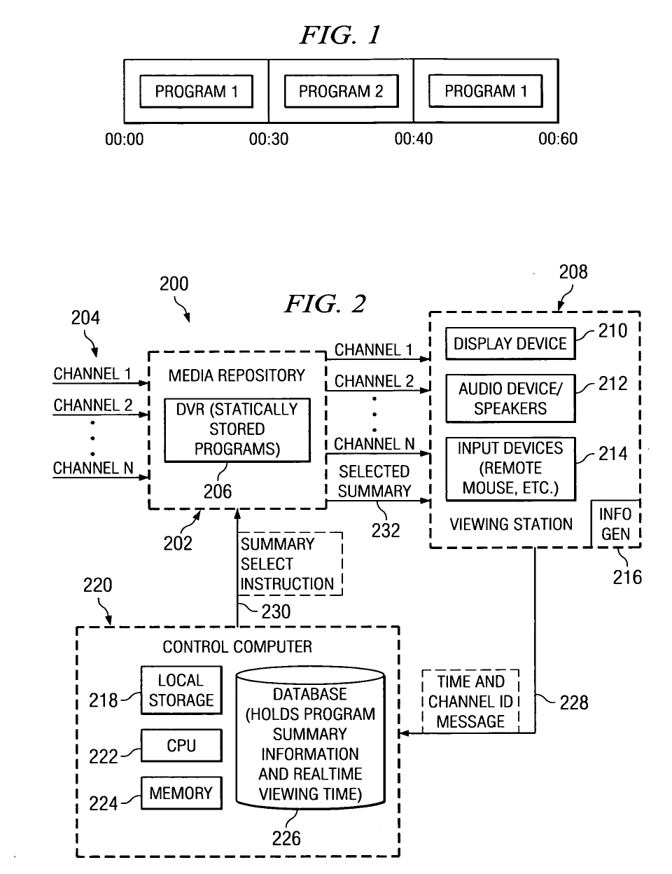

### DETAILED DESCRIPTION OF THE PREFERRED EMBODIMENT

Referring to FIG. 2, there is shown a television viewing system 200 configured to implement an embodiment of the invention. System 200 includes a media repository 202 that is connected to receive television-related media content from each of N data transmission channels, referenced collectively as 204. Each of the channels usefully comprises a conventional commercial television channel, carrying information that may be transmitted by any available transmission means. Such means include, without limitation, over the air broadcasts, satellite, cable transmission means, wireless transmission means and use of the Internet. Transmitted data may be in either digital or analog form, and generally comprises programs that fit exactly into specified time slots. Such time slots have standard lengths, such as one-half hour, one hour and two hours, and typically begin and end on the hour or half hour.

The data transmitted through each of the N channels is multi-media data, and thus includes video content and corresponding audio content. Accordingly, a conventional television receiver tuned to any of the channels will be able to decode the data transmitted thereby, to display video images and accompanying sound or audio information. The video images may also be accompanied by other related information, such as text messages or the like.

FIG. 2 further shows media repository 202 provided with a video recording device 206, such as a digital video recorder (DVR). DVR 206 is operated to record all the content carried by the respective channels 1-N. Recorded content is stored in DVR 206 for only a specified period of time, following the end of its respective assigned time slot. In an alternative embodiment, described hereinafter in connection with FIG. 5, a media repository 502 can be substituted for the repository 202 of system 200.

FIG. 2 shows respective channels 1-N connected from media repository 202 to a viewer station 208, comprising a display device 210, speakers and related audio components 212, and input devices 214. Viewing station 208 may, in fact, comprise a conventional television set or receiver, provided with some modifications needed for embodiments of the invention. Thus, viewing station 208 would include a tuner or other channel selector (not shown) for use in selecting any one of the N channels. The video content of the selected channel is displayed as a succession of video images by means of display device 210. The audio content is produced as sound accompanying the video images, by means of speakers 212, and operation of station 208 is controlled by the input devices 214. The devices 214 may include a standard television remote control, and may further include a mouse or other input device for use with an associated computer, such as control computer 220 shown in FIG. 2.

Viewer station 208 is further provided with an information generator 216, for monitoring respective channels that are selected by station 208 for viewing. More particularly, each time a user of viewing station 208 tunes to a particular channel for viewing, the identity of the selected channel, together with the exact time of selection, is sent to computer 220. The exact time that station 208 tunes away from a channel, to select a different channel, is also furnished to computer 220. This information is sent by means of a Time & Channel ID message 228.

As stated previously, when a viewer selects a television program that is already in progress, it would be desirable to provide the viewer with a summary of the program portion that was missed. To achieve this, control computer 220 is provided, which comprises a central processing unit (CPU) 222, a cache or local storage 218, a memory 224 and a database 226. In the embodiment of FIG. 2, computer 220 contains a control program, which controls operation of CPU 222 and computer 220. The messages 228 received from viewing station 208 are usefully stored in database 226. As described hereinafter in further detail, control computer 220 cooperatively interacts with media repository 202, to provide necessary summary information to viewing station 208.

FIG. 2 further shows that for each channel 1-N, the entire media content of a program, transmitted to viewer station 208 during a time slot, is stored in DVR 206. Usefully, such media content is stored in the form of Moving Picture Expert Group (MPEG) files. The content for a given program may be automatically removed from DVR 206, either immediately following the end of the program or at a specified time thereafter.

In one embodiment of the invention, when a particular program is being received by DVR 206, summaries of successive program segments for the program are also being received thereby. More specifically, after a television program has been created or produced, it is divided into a number of time segments, wherein each segment includes one or more significant program events. Those who create the program will assign times to delimit successive segments, and will also create a summary directed to the significant events of each segment. Each segment summary could, for example, simply comprise a brief textual statement. Thus, if the program is a talk show, segment summaries for the program could, as an example, include the following:

| Time | Segment Summary |
|---|---|
| 00:00 | Opening Remarks |
| 00:30 | Phone calls from viewers |
| 00:35 | Commercial |
| 01:15 | Guest X starts talking |
| 03:00 | Guest X leaves |

Referring further to FIG. 2, there is shown a summary select instruction 230, being sent to media repository 202 from control computer 220. As described hereinafter in further detail, the information provided by a message 228, received by control computer 220 from viewer station 208, is used to determine whether a user at station 208 missed a previous portion of the program then being viewed. If so, computer 220 sends an instruction 230 identifying the missed program portion to media repository 206. The information contained in the instruction 230 is used by repository 202 to select the summary segment or segments that cover or coincide with the missed program portion. The selected segments are then sent to viewing station 208, by means of a link 232.

If the summary segments comprise text, they may be presented to a user of station 208 by successively scrolling the textual segments along the bottom of display device 210. Use of other types of media for the program summaries, such as video and/or audio media, are described hereinafter in further detail.

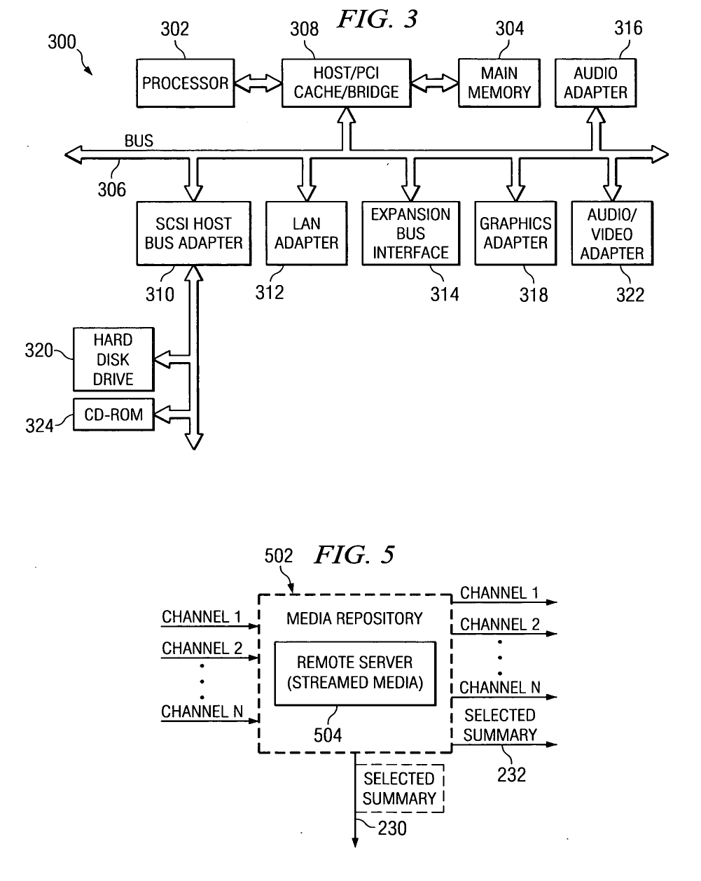

Referring to FIG. 3, there is shown a block diagram of a generalized data processing system 300 which may be adapted for use as the control computer 220 in the system 200 shown in FIG. 2. Data processing system 300 exemplifies a computer, in which code or instructions for implementing the processes of the present invention may be located. Data processing system 300 usefully employs a peripheral component interconnect (PCI) local bus architecture, although other bus architectures such as Accelerated Graphics Port (AGP) and Industry Standard Architecture (ISA) may alternatively be used. FIG. 3 shows a processor 302 and main memory 304 connected to a PCI local bus 306 through a Host/PCI bridge 308. PCI bridge 308 also may include an integrated memory controller and cache memory for processor 302.

Referring further to FIG. 3, there is shown a local area network (LAN) adapter 312, a small computer system interface (SCSI) host bus adapter 310, and an expansion bus interface 314 respectively connected to PCI local bus 306 by direct component connection. Audio adapter 316, a graphics adapter 318, and audio/video adapter 322 are connected to PCI local bus 306 by means of add-in boards inserted into expansion slots. SCSI host bus adapter 310 provides a connection for hard disk drive 320, and also for CD-ROM drive 324. It is thus seen that data processing system 300 is provided with components that may readily be adapted for use as CPU 222, storage 218, memory 224 and database 226, respectively, of computer 220.

An operating system runs on processor 302 and is used to coordinate and provide control of various components within data processing system 300 shown in FIG. 3. The operating system may be a commercially available operating system such as Windows XP, which is available from Microsoft Corporation. Instructions for the operating system and for applications or programs are located on storage devices, such as hard disk drive 320, and may be loaded into main memory 304 for execution by processor 302.

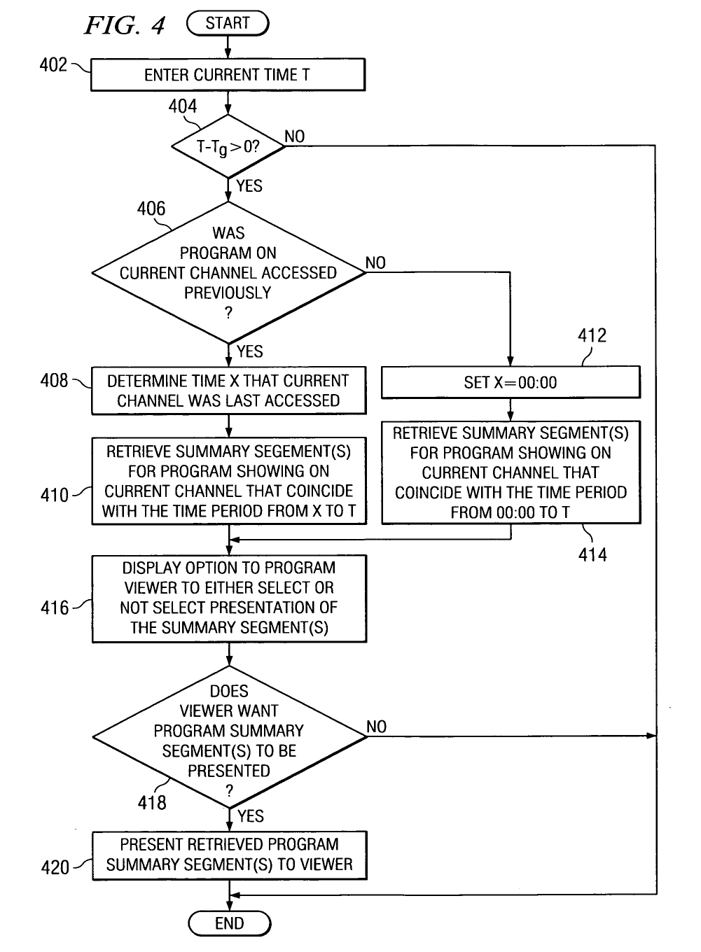

When a user of viewing station 208 switches from one channel to another, control computer 220 is notified of the change to the new channel by the Time & Channel ID message 228, as discussed above. In response to this notification, the control program in computer 220 commences the procedure shown in FIG. 4. This procedure generates a summary pertaining to the program then running on the new channel, which is now the current channel. More particularly, the summary pertains to a prior portion of the program, which was missed while viewing station 208 was tuned to the previous channel.

Referring to FIG. 4, there is shown function block 402, indicating that the first step after commencing the procedure is to enter the current time T. The time T is supplied to computer 220 by the message 228, and is the time when viewing station 208 is first switched to receive the current channel. The next step, as shown by decision block 404, is to determine whether or not the time T is greater than the start time Tₛ of the program running on the current channel. If T−Tₛ=0, it is clear that the viewing station 208 was tuned to the current channel when the program began. In this case, no portion of the program was missed, and there is no need for a summary. Accordingly, the procedure of FIG. 4 is ended. However, if T−Tₛ>0, decision block 404 provides a YES output. It thus becomes necessary to determine whether the current channel was accessed previously (after the program had begun), as shown by decision block 406.

The query of decision block 406 is readily resolved by considering data previously stored in control computer 220, by Time & Channel ID messages 228. If such data shows that the program on the current channel had been accessed previously, database 406 provides a YES output. In response to this output, the time at which the current channel was last accessed, represented as time X, must be determined as shown by function block 408. The time X is shown by data sent to computer 220, by a message 228, and is the last time that the viewing station 208 was switched away from the current channel.

Function block 408 is followed by function block 410, which indicates that the summary segment or segments for the current program, that coincide with or cover the time period between times X and T, are to be retrieved from media repository 202. This retrieval is carried out by sending an instruction 230 from computer 220 to the media repository 202, as described above. This instruction specifies the current channel, the program and the missing program portion.

Referring further to FIG. 4, if the current channel was not previously accessed, so that the output of decision block 406 is NO, the time X is set to 00:00, as shown by function block 412. Thereupon, the summary segments that coincide with the time period from the beginning of the program (at time 00:00) to the time T are retrieved, as indicated by function block 414. This retrieval likewise would be carried out by an instruction 230 sent to media repository 202.

After the conclusion of the task shown by either function block 410 or 414, an option is displayed to a viewer of station 208, as shown by decision block 416. This option informs the viewer that a selection may be made to either display or not display (or otherwise present) the summary segments provided in accordance with function block 410 or 414. Decision block 418 indicates that if the viewer does not want the program summary segments presented, the procedure of FIG. 4 ends. Otherwise, the program summary is presented to the viewer as indicated by function block 420, and then the procedure ends.

While a program summary could be presented by means of displayed textual statements, as described above, the summary could alternatively be provided in the form of audio media. For example, the statements could be presented as audible spoken words. Moreover, if a program was a sporting event such as a football game, a summary of a missed portion of the game could be presented using both video and audio media. For example, the summary could comprise a sequence of all the scoring plays and turnover plays which the viewer had missed. After the viewer had tuned to the channel carrying the game, this summary would be presented, such as by means of a split screen.

Referring to FIG. 5, there is shown a media repository 502 that may be substituted in system 200 for media repository 202. Instead of DVR 206, media repository 502 is provided with a server 504 that is remote from viewing station 208, and is connected to a network such as the Internet (not shown). The server 504 is used to stream media content through respective channels 1-N. In response to a summary select instruction 230 from control computer 220, server 504 would arrange to stream the required program summary information to viewing station 208.

The invention can take the form of an entirely hardware embodiment, an entirely software embodiment or an embodiment containing both hardware and software elements. A software embodiment of the invention could include but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. In association with an array of data transmission channels, wherein the channels are respectively connectible to a video receiver having a display device, and video content is simultaneously transmitted through each of the channels, a method comprising the steps of:
operating said video receiver to display the video content transmitted through a first one of said channels during a first time period;
further operating said video receiver to display the video content transmitted through a second one of said channels during a second time period that follows said first time period;
generating a summary of the video content transmitted through said second channel during said first time period; and
selectively presenting said summary during said second time period to a user of said video receiver.

2. The method of claim 1, wherein:
said video receiver is operated to display the video content transmitted through said first channel during a third time period that follows said second time period, and is further operated during said third time period to present said user with a summary of the video content that was transmitted through said first channel during said second time period.

3. The method of claim 1, wherein:
said method further comprises selectively storing specified information, wherein said stored information is sufficient to enable a summary to be generated for any video content that is transmitted through any of said channels, during any portion of a specified time period.

4. The method of claim 3, wherein:
the identity of each channel accessed by said video receiver during said specified time period, and the times at which access of respective channels begins and ends, is entered into a specified database; and
content of said database is used in generating each of said video content summaries.

5. The method of claim 4, wherein:
one of said summaries is generated whenever said video receiver is switched from displaying content of one channel to displaying content of a different channel.

6. The method of claim 4, wherein:
each of a plurality of said channels transmits content that comprises a complete television program, each of said programs coinciding in time with said specified time period.

7. The method of claim 4, wherein:
each channel of said array is disposed to transmit both video content and audio content corresponding to the video content, and said video receiver comprises a multi-media receiver.

8. The method of claim 7, wherein:
each of said summaries is presented by means of one or more media types, selected from a group that includes at least audio, video, pictorial, and textual media types.

9. The method of claim 3, wherein:
said user of said video receiver is enabled to optionally select either presentation or non-presentation of said video content summaries.

10. The method of claim 3, wherein:
said specified information is stored in connection with either a DVR or a remote server, selectively.

11. Apparatus comprising:
a media repository connected to multiple data transmission channels, said media repository being adapted to receive and store video content that is simultaneously transmitted through each of said channels;
a viewing station operable to receive and display the video content transmitted through a first one of said channels during a first time period, and further operable to receive and display the video content transmitted through a second one of said channels during a second time period that follows said first time period; and
a processing device operable to cause a summary of the video content transmitted through said second channel during said first time period to be sent to said viewing station, for presentation to a user of said viewing station during said second time period.

12. The apparatus of claim 11, wherein:
said viewing station is provided with a component for generating messages containing the identity of each channel accessed by said viewing station during said specified time period, and the times at which access of respective channels begins and ends; and
said processing device is adapted to receive said messages, and to enter them into a database for use in generating video content summaries.

13. The apparatus of claim 11, wherein:
said media repository is adapted to provide specified information, wherein said specified information is sufficient to enable a summary to be generated for any video content that is transmitted through any of said channels, during any portion of a specified time period.

14. The apparatus of claim 13, wherein:
said media repository includes either a DVR or a server, selectively.

15. The apparatus of claim 13, wherein:
one of said summaries is generated whenever said video receiver is switched from displaying content of one channel to displaying content of a different channel.

16. The apparatus of claim 13, wherein:
each channel of said array is disposed to transmit both video content and audio content corresponding to the video content, and said viewing station includes a multi-media receiver; and
each of said summaries is presented by means of one or more media types, selected from a group that includes at least audio, video, pictorial, graphic and textual media types.

17. In association with an array of data transmission channels, wherein the channels are respectively connectible to a video receiver having a display device, and video content is simultaneously transmitted through each of the channels, a computer program product in a computer readable medium comprising:
first instructions for operating said video receiver to display the video content transmitted through a first one of said channels during a first time period;
second instructions for further operating said video receiver to display the video content transmitted through a second one of said channels during a second time period that follows said first time period;
third instructions for generating a summary of the video content transmitted through said second channel during said first time period; and
fourth instructions for selectively presenting said summary during said second time period to a user of said video receiver.

18. The computer program product of claim 17, wherein:
said video receiver is operated to display the video content transmitted through said first channel during a third time period that follows said second time period, and is further operated during said third time period to present said user with a summary of the video content that was transmitted through said first channel during said second time period.

19. The computer program product of claim 17, wherein:
specified information is selectively stored, said stored information being sufficient to enable a summary to be generated for any video content that is transmitted through any of said channels, during any portion of a specified time period.

20. The computer program product of claim 19, wherein:
the identity of each channel accessed by said video receiver during said specified time period, and the times at which access of respective channels begins and ends, is entered into a specified database; and
content of said database is used in generating each of said video content summaries.
